(19) United States
(12) Patent Application Publication
(10) Pub. No.: US 2024/0244538 A1
(43) Pub. Date: Jul. 18, 2024

(54) UL POWER CONTROL IN IAB NODES

(71) Applicant: Telefonaktiebolaget LM Ericsson (publ), Stockholm (SE)

(72) Inventors: Magnus Åström, Lund (SE); Lei Bao, Göteborg (SE); Boris Dortschy, Vendelsö (SE); Lars Sundström, Lund (SE); Behrooz Makki, Pixbo (SE)

(21) Appl. No.: 18/558,759

(22) PCT Filed: May 11, 2022
(86) PCT No.: PCT/EP2022/062801

§ 371 Date: Nov. 3, 2023

Related U.S. Application Data
(60) Provisional application No. 63/187,103, filed on May 11, 2021.

(51) Int. Cl. H04W 52/36; H04W 52/14

(52) U.S. Cl. CPC H04W 52/367; H04W 52/146

(57) ABSTRACT

Providing uplink (UL) power control in Integrated Access and Backhaul (IAB) nodes is disclosed herein. In one embodiment of a method performed in a network node for signaling a transmission power dynamic range of its IAB Mobile Termination (IAB-MT) to a second network node, the method comprises determining at least one dynamic range between two transmission power values. The method further comprises transmitting a dynamic range report to the second network node, wherein the dynamic range report comprises the at least one dynamic range.

### RELATED APPLICATIONS

This application claims the benefit of provisional patent application Ser. No. 63/187,103, filed May 11, 2021, the disclosure of which is hereby incorporated herein by reference in its entirety.

### TECHNICAL FIELD

The present disclosure relates to power control among Integrated Access and Backhaul (IAB) nodes in a cellular communications system.

### BACKGROUND

### Integrated Access and Backhaul Overview

Densification via the deployment of increasing the number of base stations (be they macro- or micro-base stations) is one of the mechanisms that can be employed to satisfy the ever-increasing demand for more and more bandwidth/capacity in mobile networks. Due to the availability of more spectrum in the millimeter wave (mmW) band, deploying small cells that operate in this band is an attractive deployment option for these purposes. However, deploying fiber to the small cells, which is the usual way in which small cells are deployed, can end up being very expensive and impractical. Thus, employing a wireless link for connecting the small cells to the operator's network is a cheaper and practical alternative with more flexibility and shorter time-to-market. One such solution is an Integrated Access and Backhaul (IAB) network, where the operator can utilize part of the radio resources for the backhaul link.

In FIG. 1, an IAB deployment that supports multiple hops is presented. The IAB donor node (in short IAB donor) has, e.g., a wired, connection to the core network and the IAB nodes are wirelessly connected using NR to the IAB donor, either directly or indirectly via another IAB node. The connection between IAB donor/node and UEs is called access link, whereas the connection between two IAB nodes or between an IAB donor and an IAB node is called backhaul link. IAB nodes are also referred to herein as “IAB network nodes.”

Furthermore, as shown in FIG. 2, the adjacent upstream node which is closer to the IAB donor node of an IAB node is referred to as a parent node of the IAB-node. The adjacent downstream node which is further away from the IAB donor node of an IAB node is referred to as a child node of the IAB-node. The backhaul link between the parent node and the IAB-node is referred to as parent (backhaul) link, whereas the backhaul link between the IAB-node and the child node is referred to as child (backhaul) link.

### IAB Architecture

As one major difference of the IAB architecture compared to Rel-10 LTE relay (besides lower layer differences) is that the IAB architecture adopts the Central-Unit/Distributed-Unit (CU/DU) split of gNBs in which time-critical functionalities are realized in DU closer to the radio, whereas the less time-critical functionalities are pooled in the CU with the opportunity for centralization. Based on this architecture, an IAB-donor contains both CU and DU functions. In particular, it contains all CU functions of the IAB-nodes under the same IAB-donor. Each IAB-node then hosts the DU function(s) of a gNB. In order to be able to transmit/receive wireless signals to/from the upstream IAB-node or IAB-donor, each IAB-node has a mobile termination (MT), a logical unit providing a necessary set of UE-like functions. Via the DU, the IAB-node establishes RLC-channel to UEs and/or to MTs of the connected IAB-node(s). Via the MT, the IAB-node establishes the backhaul radio interface towards the serving IAB-node or IAB-donor. FIG. 3 shows a reference diagram for a two-hop chain of IAB-nodes under an IAB-donor.

### IAB Topologies

Wireless backhaul links are vulnerable to blockage, e.g., due to moving objects such as vehicles, due to seasonal changes (foliage), severe weather conditions (rain, snow or hail), or due to infrastructure changes (new buildings). Such vulnerability also applies to IAB-nodes. Also, traffic variations can create uneven load distribution on wireless backhaul links leading to local link or node congestion. In view of those concerns, the IAB topology supports redundant paths as another difference compared to the Rel-10 LTE relay.

The following topologies are considered in IAB as shown in FIG. 4:
Spanning tree (ST)
Directed acyclic graph (DAG)

It means that one IAB node can have multiple child nodes and/or have multiple parent nodes. The multi-connectivity or route redundancy may be used for back-up purposes. It is also possible that redundant routes are used concurrently, e.g., to achieve load balancing, reliability, etc.

### Resource Configuration

### Time-Domain Resource Coordination

In case of in-band operation, the IAB-node is typically subject to the half-duplex constraint, i.e., an IAB-node can only be in either transmission or reception mode at a time. Rel-16 IAB mainly consider the time-division multiplexing (TDM) case where the MT and DU resources of the same IAB-node are separated in time. Based on this consideration, the following resource types have been defined for IAB MT and DU, respectively.

From an IAB-node MT point-of-view, as in Rel-15, the following time-domain resources can be indicated for the parent link:
Downlink (DL) time resource
Uplink (UL) time resource
Flexible (F) time resource

From an IAB-node DU point-of-view, the child link has the following types of time resources:
DL time resource
UL time resource
F time resource
Not-available (NA) time resources (resources not to be used for communication on the DU child links)

Each of the downlink, uplink and flexible time-resource types of the DU child link can belong to one of two categories:
Hard (H): The corresponding time resource is always available for the DU child link
Soft (S): The availability of the corresponding time resource for the DU child link is explicitly and/or implicitly controlled by the parent node.

The IAB DU resources are configured per cell, and the H/S/NA attributes for the DU resource configuration are explicitly indicated per-resource type (D/U/F) in each slot. As a result, the semi-static time-domain resources of the DU part can be of seven types in total: Downlink-Hard (DL-H), Downlink-Soft (DL-S), Uplink-Hard (UL-H), Uplink-Soft (UL-S), Flexible-Hard (F-H), Flexible-Soft (F-S), and Not-Available (NA). The coordination relation between MT and DU resources are listed in Table 1.

TABLE 1
Coordination between MT and DU resources of an IAB-node.

| | | MT configuration | | |
|---|---|---|---|---|
| | | DL | UL | Flexible |
| DU | DL-H | DU: can transmit | DU: can transmit | DU: can transmit |
| configuration | | on DL | on DL | on DL |
| | | unconditionally; | unconditionally; | unconditionally; |
| | | MT: not | MT: not | MT: not |
| | | available. | available. | available. |
| | DL-S | DU: can transmit | DU: can transmit | DU: can transmit |
| | | conditionally; | conditionally; | conditionally; |
| | | MT: available on | MT: available on | MT: available on |
| | | DL. | UL. | DL & UL. |
| | UL-H | DU: can | DU: can | DU: can |
| | | schedule UL | schedule UL | schedule UL |
| | | unconditionally; | unconditionally; | unconditionally; |
| | | MT: not | MT: not | MT: not |
| | | available. | available. | available. |
| | UL-S | DU: can | DU: can | DU: can |
| | | schedule UL | schedule UL | schedule UL |
| | | conditionally; | conditionally; | conditionally; |
| | | MT: available on | MT: available on | MT: available on |
| | | DL. | UL. | DL & UL. |
| | F-H | DU: can transmit | DU: can transmit | DU: can transmit |
| | | on DL or | on DL or | on DL or |
| | | schedule UL | schedule UL | schedule UL |
| | | unconditionally; | unconditionally; | unconditionally; |
| | | MT: not | MT: not | MT: not |
| | | available. | available. | available. |
| | F-S | DU: can transmit | DU: can transmit | DU: can transmit |
| | | on DL or | on DL or | on DL or |
| | | schedule UL | schedule UL | schedule UL |
| | | conditionally; | conditionally; | conditionally; |
| | | MT: available on | MT: available on | MT: available on |
| | | DL. | UL. | DL & UL. |
| | NA | DU: not | DU: not | DU: not |
| | | available; | available; | available; |
| | | MT: available on | MT: available on | MT: available on |
| | | DL. | UL. | DL & UL. |

One example of such IAB DU configuration is in FIG. 5.

### Frequency-Domain Resource Configuration

One of the objectives in the Rel-17 IAB WID RP-201293 is to have “specification of enhancements to the resource multiplexing between child and parent links of an IAB node, including: support of simultaneous operation (transmission and/or reception) of IAB-node's child and parent links (i.e., MT Tx/DU Tx, MT Tx/DU Rx, MT Rx/DU Tx, MT Rx/DU Rx).” FIG. 6 illustrates examples of frequency-domain DU resource configuration.

### Capability Indication

To facilitate the resource configuration, 3GPP has agreed in RAN1 #98b is that:

“The donor CU and the parent node can be made aware of the multiplexing capability between MT and DU (TDM required, TDM not required) of an IAB node to for any {MT CC, DU cell} pair.”

RAN1 #99 has further detailed the indication of the multiplexing capability as: “The indication of the multiplexing capability for the case of no-TDM between IAB MT and IAB DU is additionally provided with respect to each transmission-direction combination (per MT CC/DU cell pair):
MT-TX/DU-TX
MT-TX/DU-RX
MT-RX/DU-TX
MT-RX/DU-RX

The corresponding signaling has been defined in TS 38.473, clause 9.3.1.108 as part of the F1 application protocol (F1-AP) information element (IE), which is an L3 signaling.

### Power Control

Generally, from a resource efficiency perspective, it is desirable to receive an as strong signal as possible, since that will maximize SNR and thereby throughput. The fundamental rationale for power control is to provide a signal that allows the receiver to operate in its linear range. A too weak signal will not be detected, and a too strong signal may saturate the receiver, distorting the signal. To some amount, the receiver can adjust its amplification and thereby mitigate a too weak or too strong signal. However, in case multiple UEs are connected to the same cell, the receiver may need a minimum amplification to receive the weakest UE, alternatively, a maximum amplification to receive the strongest UE. Hence, practically, the receiver amplification may be restricted in its dynamic range.

A cell's coverage is related to receiver linearity such that the cell's DU must be able to receive a nearest UE with the lowest specified transmit power simultaneously as it receives a furthest UE with the highest specified transmit power.

The above problems are further exacerbated by the introduction of IAB nodes that are expected to use a higher transmit power than normal UEs and have a planned deployment ascertaining good parent link properties. Hence, simultaneously receiving from an IAB node and a UE may result in even higher requirements on the parent IAB node's receiver or the IAB node's ability to perform power control such that the IAB-MT transmits with a power level closer to that of what a UE would use.

### Adjacent Channel Leakage

Adjacent channel leakage is the amount of transmit power on an assigned channel that is received in an adjacent channel after a receive filter. This leakage originates from various transmitter imperfections including, RF power amplifier nonlinearity, finite selectivity of filters, transmit waveform generation, and up-conversion from baseband to RF, causing the transmitted signal to spread beyond what is desired. Since the leakage is typically proportional to the transmit power, it is represented as a ratio between the power in the assigned channel to the power in the adjacent channel.

Provided a transmitter uses the same power spectral density across the carrier, the ACLR from the IAB-DU spectrum into the IAB-MT spectrum corresponds to existing ACLR requirements for an adjacent carrier. However, if the IAB-MT is power controlled by its parent IAB node, the part of the carrier that is used by the IAB-DU may cause larger interference in the part of the spectrum that is used by the IAB-MT due to the IAB-MT using a lower transmit power, see FIG. 7.

### SUMMARY

Methods and apparatus are disclosed herein for providing uplink (UL) power control in Integrated Access and Backhaul (IAB) nodes. Embodiments of a method performed in a network node for signaling a transmission power dynamic range of its IAB Mobile Termination (IAB-MT) to a second network node are disclosed herein. The method comprises determining at least one dynamic range between two transmission power values. The method further comprises transmitting a dynamic range report to the second network node, wherein the dynamic range report comprises the at least one dynamic range. In some embodiments, the two transmission power values comprise a maximum transmission power value and an offset. Some such embodiments may provide that the offset comprises a difference between the maximum transmission power and an IAB-MT desired minimum transmit power. According to some such embodiments, the offset is defined by a Power Headroom Report (PHR).

In some embodiments, the two transmission power values comprise a maximum transmission power value and a minimum transmission power value. Some embodiments may provide that the two transmission power values comprise a present transmission power value and a minimum transmission power value. According to some such embodiments, the minimum transmission power value comprises either one of an absolute minimum transmission power value or a preferred minimum transmission power value. In some such embodiments, the preferred minimum transmission power value is related to a mode of operation in the IAB network node. Some such embodiments may provide that the preferred minimum transmission power value is associated with simultaneous operation of IAB-MT and IAB Distributed Unit (IAB-DU).

According to some embodiments, the at least one dynamic range is based on a mode of operation in the IAB network node. In some such embodiments, the mode of operation comprises one or more of frequency domain resource multiplexing, spatial domain resource multiplexing or time domain resource multiplexing. Some embodiments may provide that the maximum transmission power value is set in relation to an IAB-DU specified maximum transmit power. According to some embodiments, the method further comprises, prior to determining the at least one dynamic range, receiving a frequency resource configuration. In some such embodiments, the preferred minimum transmission power is related to one or more of a frequency separation between an IAB-MT and an IAB-DU allocation in a carrier and the bandwidth of the transmissions of the IAB-DU or the IAB-MT. Some such embodiments may provide that the method further comprises, subsequent to transmitting the dynamic range report, receiving a configuration message from the second network node, and configuring the IAB network node according to the configuration message.

According to some embodiments, the dynamic range report is part of a capability report. In some such embodiments, the capability report comprises a multiplexing capability report. Some embodiments may provide that the dynamic range report is part of a Radio Resource Control (RRC) message, an F1 Application Protocol, F1ap, message, or a Medium Access Control (MAC) control element (CE) message. According to some embodiments, the second network node comprises a Central Unit (CU). In some embodiments, the dynamic range report is part of an Operations, Administration and Maintenance (OAM) report. Some embodiments may provide that the second network node comprises a parent IAB network node, the configuration message comprises an UL power control message, and configuring the IAB network node according to the configuration message comprises configuring an IAB-MT transmit power configuration. According to some such embodiments, the method further comprises determining, by the IAB network node, that a change in simultaneous operation mode is required, signaling a dynamic change in simultaneous operation mode to the parent IAB network node.

Embodiments of an IAB network node for signaling a transmission power dynamic range of its IAB-MT to a second network node are also disclosed herein. The IAB network node comprises one or more transmitters, one or more receivers, and processing circuitry associated with the one or more transmitters and the one or more receivers. The processing circuitry is configured to determine at least one dynamic range between two transmission power values. The processing circuitry is further configured to transmit a dynamic range report to the second network node, wherein the dynamic range report comprises the at least one dynamic range. In some embodiments, the processing circuitry is further configured to perform any of the operations attributed to the IAB network node above.

Embodiments of an IAB network node for signaling a transmission power dynamic range of its IAB-MT to a second network node are also disclosed herein. The IAB network node is adapted to determine at least one dynamic range between two transmission power values. The IAB network node is further adapted to transmit a dynamic range report to the second network node, wherein the dynamic range report comprises the at least one dynamic range. Some embodiments may provide that the IAB network node is further adapted to perform any of the operations attributed to the IAB network node above.

Embodiments of a method performed in an IAB parent network node for configuring an IAB network node are also disclosed herein. The method comprises receiving a dynamic range report from the IAB network node, the dynamic range report comprising at least one dynamic range between two transmission power values. The method further comprises determining a configuration of the IAB network node based on the dynamic range report. The method also comprises transmitting a configuration message comprising the configuration to the IAB network node. Some embodiments may provide that the two transmission power values comprise a maximum transmission power value and an offset. In some such embodiments, the offset comprises a difference between the maximum transmission power and an IAB-MT desired minimum transmit power. Some such embodiments may provide that the offset is defined by a PHR.

According to some embodiments, the two transmission power values comprise a maximum transmission power value and a minimum transmission power value. In some such embodiments, the minimum transmission power value comprises one of an absolute minimum transmission power value and a preferred minimum transmission power value. Some such embodiments may provide that the preferred minimum transmission power value is related to a mode of operation in the IAB network node. According to some such embodiments, the preferred minimum transmission power value is associated with simultaneous operation of IAB-MT and IAB-DU. In some embodiments, the at least one dynamic range is based on a mode of operation in the IAB network node. Some such embodiments may provide that the mode of operation comprises one or more of frequency domain resource multiplexing, spatial domain resource multiplexing or time domain resource multiplexing. According to some embodiments, the maximum transmission power value is set in relation to an IAB-DU specified maximum transmit power.

In some embodiments, the configuration message comprises an UL power control message. Some embodiments may provide that the method further comprises comparing the dynamic range report to a threshold for simultaneous operation. According to some such embodiments, the method further comprises, responsive to determining that the IAB network node is capable of simultaneous operation, determining a configuration for simultaneous operation. In some such embodiments, the method further comprises, responsive to determining that the IAB network node is capable of simultaneous operation given a change in configuration, signaling the change in configuration and a configuration for simultaneous operation to the IAB network node. Some such embodiments may provide that simultaneous operation comprises simultaneous transmission of IAB-MT and IAB-DU signals. According to some such embodiments, the threshold for simultaneous operation is based on the receiver linearity of the parent IAB node. In some embodiments, the configuration is valid for a subset of slots. Some embodiments may provide that the configuration comprises one or more of a mode of simultaneous operation, a mode of no simultaneous operation, power control, and timing.

Embodiments of an IAB parent network node for configuring an IAB network node are also disclosed herein. The IAB parent network node comprises one or more transmitters, one or more receivers, and processing circuitry associated with the one or more transmitters and the one or more receivers. The processing circuitry is configured to receive a dynamic range report from the IAB network node, the dynamic range report comprising at least one dynamic range between two transmission power values. The processing circuitry is further configured to determine a configuration of the IAB network node based on the dynamic range report. The processing circuitry is also configured to transmit a configuration message comprising the configuration to the IAB network node. According to some embodiments, the processing circuitry is further configured to perform any of the operations attributed to the IAB parent network node above.

Embodiments of an IAB parent network node for configuring an IAB network node are also disclosed herein. The IAB parent network node is adapted to receive a dynamic range report from the IAB network node, the dynamic range report comprising at least one dynamic range between two transmission power values. The IAB parent network node is further adapted to determine a configuration of the IAB network node based on the dynamic range report. The IAB parent network node is also adapted to transmit a configuration message comprising the configuration to the IAB network node. In some embodiments, the IAB parent network node is further adapted to perform any of the operations attributed to the IAB parent network node above.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an exemplary Integrated Access and Backhaul (IAB) deployment that supports multiple hops, according to some embodiments disclosed herein;

FIG. 2 illustrates another exemplary IAB deployment, according to some embodiments disclosed herein;

FIG. 3 provides a reference diagram for a two-hop chain of IAB-nodes under an IAB-donor; according to some embodiments disclosed herein;

FIG. 4 illustrates exemplary IAB topologies, according to some embodiments disclosed herein;

FIG. 5 illustrates an exemplary IAB Distributed Unit (DU) configuration, according to some embodiments disclosed herein;

FIG. 6 illustrates examples of frequency domain DU resource configuration, according to some embodiments disclosed herein;

FIG. 7 illustrates a scenario in which a part of a carrier that is used by an IAB-DU may cause larger interference in a part of a spectrum that is used by IAB Mobile Termination (IAB-MT) due to the IAB-MT using a lower transmit power, according to some embodiments disclosed herein;

FIG. 8 illustrates one example of a cellular communications system according to some embodiments disclosed herein;

FIGS. 9 and 10 illustrate example embodiments in which the cellular communication system of FIG. 3 is a Fifth Generation (5G) System (5GS);

FIG. 11 illustrates an exemplary IAB network in which an IAB node may be connected upstream to a parent IAB node and downstream to a child IAB node, according to some embodiments disclosed herein;

FIG. 12 illustrates exemplary operations for signaling a power transmission dynamic range of an IAB node to another network node, according to some embodiments disclosed herein;

FIG. 13 illustrates relationships between transmission powers of an IAB node that may be used to determine a transmission dynamic range, according to some embodiments disclosed herein;

FIG. 14 illustrates exemplary operations performed by a parent IAB node for configuring an IAB node, according to some embodiments disclosed herein;

FIG. 15 illustrates how a dynamic range report and a power headroom report may be employed to determine whether an IAB node is capable of a certain mode of operation; according to some embodiments disclosed herein;

FIG. 16 illustrates a radio access node according to some embodiments disclosed herein;

FIG. 17 illustrates a virtualized embodiment of the radio access node of FIG. 16 according to some embodiments disclosed herein;

FIG. 18 illustrates the radio access node of FIG. 16 according to some other embodiments disclosed herein;

FIG. 19 illustrates a UE according to some embodiments disclosed herein; and

FIG. 20 illustrates the UE of FIG. 19 according to some other embodiments disclosed herein.

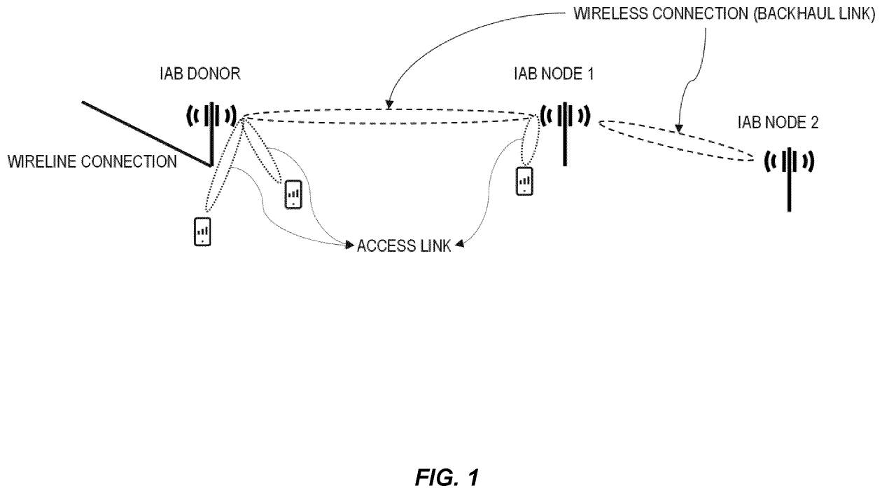

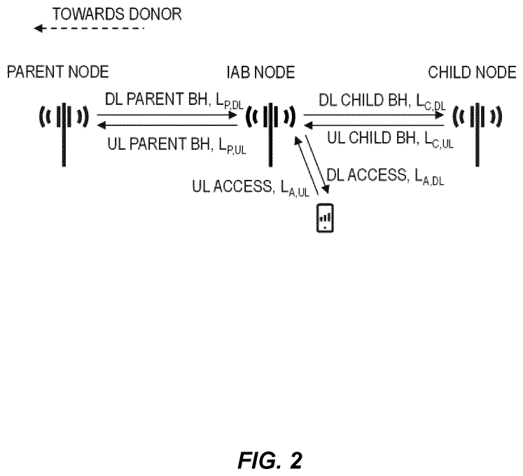

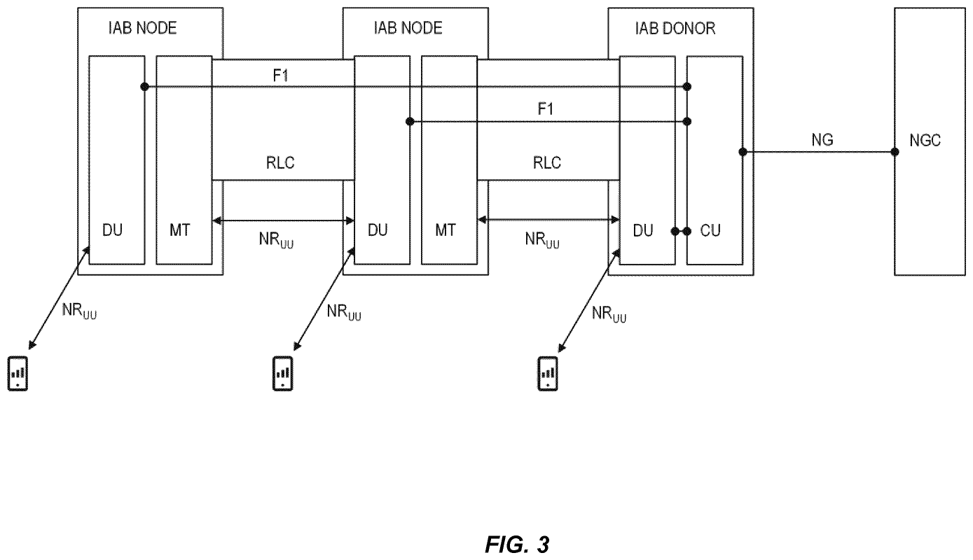

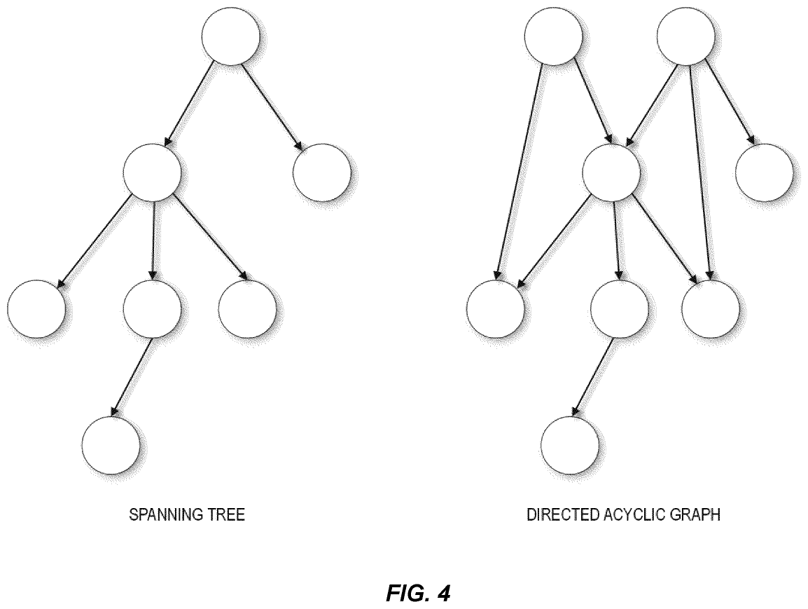

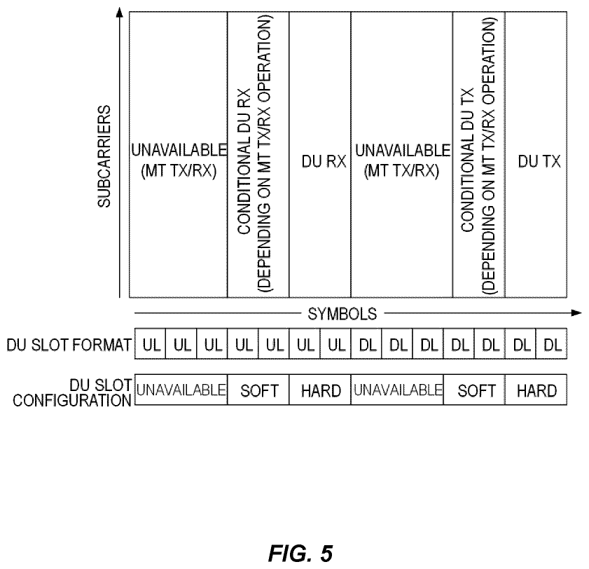

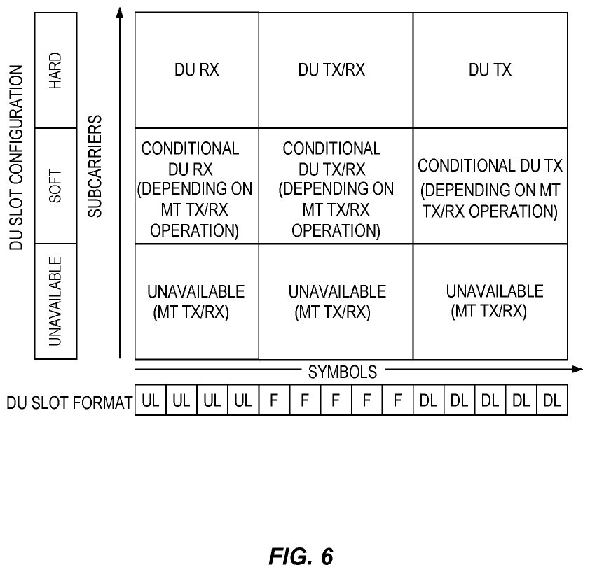

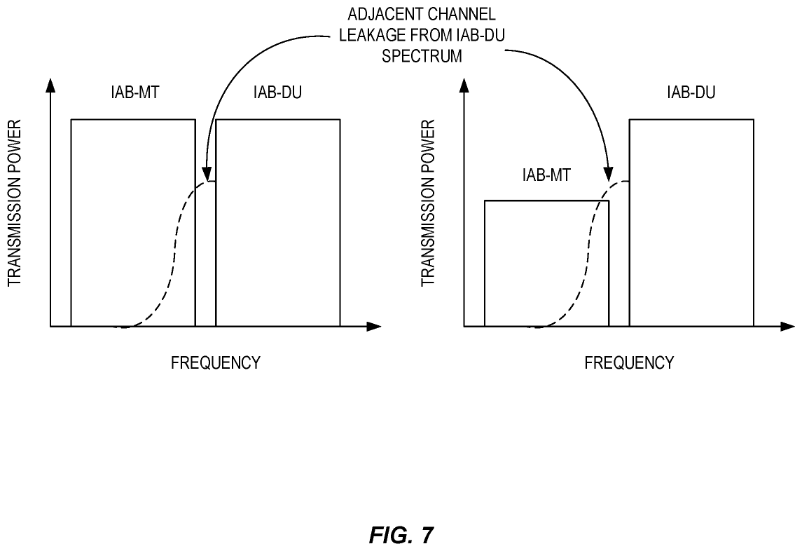

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). In particular, present power control in cellular networks assumes transmission power is always in short supply due to battery operated UEs have limited resources. For that reason, the UE may signal the present transmission power level in relation to its maximum power level using a Power Headroom report. For IAB nodes, and in particular wide-area IAB nodes, to co-exist with low power UEs or local-area IAB nodes, instead, too high output power from the IAB-MT may cause linearity problems in a parent IAB-DU to simultaneously receive/resolve the high power IAB transmission and the low power UE transmission and/or the cases with too different transmit powers of different IAB-MTs. On the other hand, operating an IAB node in simultaneous IAB-MT and IAB-DU transmission mode, with a too large difference in transmission power between the IAB-MT and IAB-DU, may cause the adjacent channel leakage from the IAB-DU transmission, resulting in too high interference due to insufficient EVM or ACLR margins in the spectrum used by the IAB-MT. For that reason, there is a need for a power control method, also taking the minimum transmission power into account in communication between a parent IAB node and an IAB node and to also configure the IAB node based on its transmission power level.

Aspects of the present disclosure and their embodiments may provide solutions to the aforementioned or other challenges. A set of methods for allowing a parent base station to control the power in an IAB-node such that it can co-exist with a lower power device are disclosed herein. In one aspect, embodiments provide a method in an IAB node to provide information about a transmission power dynamic range and to signal a report thereof to another network node. In another aspect, embodiments provide a method in a parent IAB node to receive a transmission dynamic range report and to determine and signal a configuration of the IAB node based on the received report.

Certain embodiments may provide one or more of the following technical advantage(s). The advantages of embodiments disclosed herein are that it enables an IAB node configure its operation to its preferred conditions. If the difference in transmit power is too large between the IAB-DU (that typically has a fixed transmit power) and IAB-MT, the IAB-DU may cause interference in the IAB-MT transmission due to distortion of the IAB-DU transmission extending into the IAB-MT transmission depending on the separation of used spectrum between the two and the bandwidth of the IAB-DU transmission or IAB-MT transmissions. Embodiments disclosed herein allow the IAB node to be configured to avoid such leakage for the case where its IAB-MT transmit power is above a specified level. The parent node, on the other hand, may collocate transmissions from the IAB-MT with those of other IAB-MTs or UEs if conditions allow.

Before discussing controlled UL power control in IAB nodes in greater detail, the following terms are first defined:

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IOT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set of Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

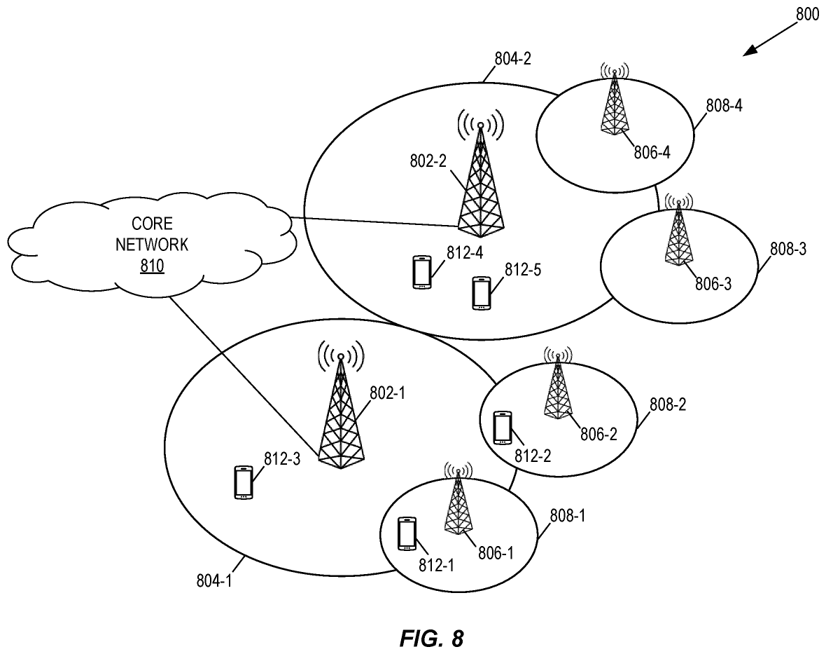

FIG. 8 illustrates one example of a cellular communications system 800 in which embodiments of the present disclosure may be implemented. In the embodiments described herein, the cellular communications system 800 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 802-1 and 802-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 804-1 and 804-2. The base stations 802-1 and 802-2 are generally referred to herein collectively as base stations 802 and individually as base station 802. Likewise, the (macro) cells 804-1 and 804-2 are generally referred to herein collectively as (macro) cells 804 and individually as (macro) cell 804. The RAN may also include a number of low power nodes 806-1 through 806-4 controlling corresponding small cells 808-1 through 808-4. The low power nodes 806-1 through 806-4 can be small base stations (such as pico or femto base stations) or RRHs, or the like. Notably, while not illustrated, one or more of the small cells 808-1 through 808-4 may alternatively be provided by the base stations 802. The low power nodes 806-1 through 806-4 are generally referred to herein collectively as low power nodes 806 and individually as low power node 806. Likewise, the small cells 808-1 through 808-4 are generally referred to herein collectively as small cells 808 and individually as small cell 808. The cellular communications system 800 also includes a core network 810, which in the 5G System (5GS) is referred to as the 5GC. The base stations 802 (and optionally the low power nodes 806) are connected to the core network 810.

The base stations 802 and the low power nodes 806 provide service to wireless communication devices 812-1 through 812-5 in the corresponding cells 804 and 808. The wireless communication devices 812-1 through 812-5 are generally referred to herein collectively as wireless communication devices 812 and individually as wireless communication device 812. In the following description, the wireless communication devices 812 are oftentimes UEs, but the present disclosure is not limited thereto.

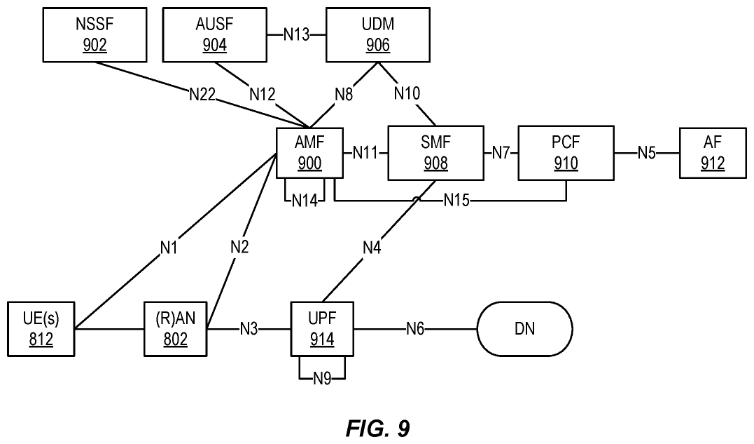

FIG. 9 illustrates a wireless communication system represented as a 5G network architecture composed of core Network Functions (NFs), where interaction between any two NFs is represented by a point-to-point reference point/interface. FIG. 9 can be viewed as one particular implementation of the system 800 of FIG. 8.

Seen from the access side the 5G network architecture shown in FIG. 9 comprises a plurality of UEs 812 connected to either a RAN 802 or an Access Network (AN) as well as an AMF 900. Typically, the R(AN) 802 comprises base stations, e.g., such as eNBs or gNBs or similar. Seen from the core network side, the 5GC NFs shown in FIG. 9 include a NSSF 902, an AUSF 904, a UDM 906, the AMF 900, a SMF 908, a PCF 910, and an Application Function (AF) 912.

Reference point representations of the 5G network architecture are used to develop detailed call flows in the normative standardization. The N1 reference point is defined to carry signaling between the UE 812 and AMF 900. The reference points for connecting between the AN 802 and AMF 900 and between the AN 802 and UPF 914 are defined as N2 and N3, respectively. There is a reference point, N11, between the AMF 900 and SMF 908, which implies that the SMF 908 is at least partly controlled by the AMF 900. N4 is used by the SMF 908 and UPF 914 so that the UPF 914 can be set using the control signal generated by the SMF 908, and the UPF 914 can report its state to the SMF 908. N9 is the reference point for the connection between different UPFs 914, and N14 is the reference point connecting between different AMFs 900, respectively. N15 and N7 are defined since the PCF 910 applies policy to the AMF 900 and SMF 908, respectively. N12 is required for the AMF 900 to perform authentication of the UE 812. N8 and N10 are defined because the subscription data of the UE 812 is required for the AMF 900 and SMF 908.

The 5GC network aims at separating UP and CP. The UP carries user traffic while the CP carries signaling in the network. In FIG. 9, the UPF 914 is in the UP and all other NFs, i.e., the AMF 900, SMF 908, PCF 910, AF 912, NSSF 902, AUSF 904, and UDM 906, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 900 and SMF 908 are independent functions in the CP. Separated AMF 900 and SMF 908 allow independent evolution and scaling. Other CP functions like the PCF 910 and AUSF 904 can be separated as shown in FIG. 9. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

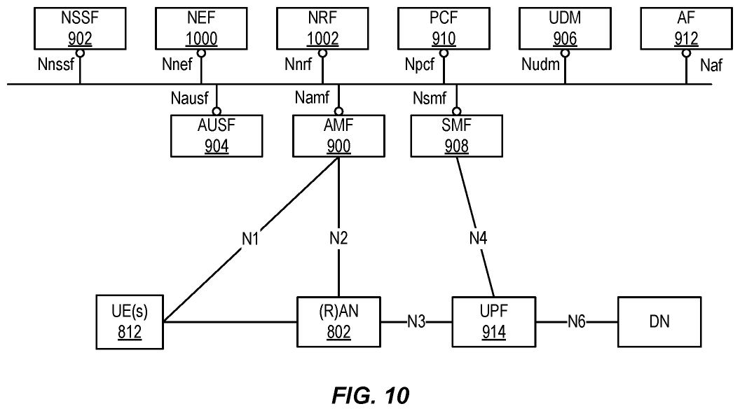

FIG. 10 illustrates a 5G network architecture using service-based interfaces between the NFs in the CP, instead of the point-to-point reference points/interfaces used in the 5G network architecture of FIG. 9. However, the NFs described above with reference to FIG. 9 correspond to the NFs shown in FIG. 10. The service(s) etc. that a NF provides to other authorized NFs can be exposed to the authorized NFs through the service-based interface. In FIG. 10 the service based interfaces are indicated by the letter “N” followed by the name of the NF, e.g., Namf for the service based interface of the AMF 900 and Nsmf for the service based interface of the SMF 908, etc. The NEF 1000 and the NRF 1002 in FIG. 10 are not shown in FIG. 9 discussed above. However, it should be clarified that all NFs depicted in FIG. 9 can interact with the NEF 1000 and the NRF 1002 of FIG. 10 as necessary, though not explicitly indicated in FIG. 9.

Some properties of the NFs shown in FIGS. 9 and 10 may be described in the following manner. The AMF 900 provides UE-based authentication, authorization, mobility management, etc. A UE 812 even using multiple access technologies is basically connected to a single AMF 900 because the AMF 900 is independent of the access technologies. The SMF 908 is responsible for session management and allocates Internet Protocol (IP) addresses to UEs. It also selects and controls the UPF 914 for data transfer. If a UE 812 has multiple sessions, different SMFs 908 may be allocated to each session to manage them individually and possibly provide different functionalities per session. The AF 912 provides information on the packet flow to the PCF 910 responsible for policy control in order to support QoS. Based on the information, the PCF 910 determines policies about mobility and session management to make the AMF 900 and SMF 908 operate properly. The AUSF 904 supports authentication function for UEs or similar and thus stores data for authentication of UEs or similar while the UDM 906 stores subscription data of the UE 812. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

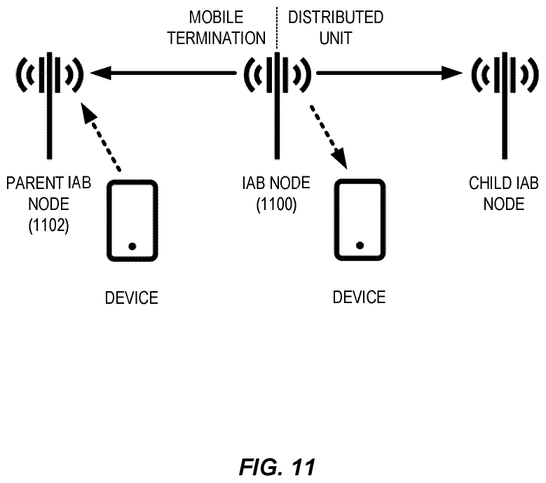

The context of the invention, as illustrated in FIG. 11, is an IAB network where an IAB node 1100 may be connected upstream to a parent IAB node 1102 and downstream to a device and/or a child IAB node. The parent IAB node 1102 may, in turn, also connect a device, or other IAB nodes. If two nodes (including IAB nodes and UEs) are configured to be received simultaneously at the parent IAB node 1102, their received power at the parent IAB node 1102, for respective node, must not differ too much, say within 10 dB, for the parent IAB node 1102 to be able to decode both signals. To obtain approximately the same receive power, the parent IAB node 1102 can configure the transmitting node to increase or decrease its transmission power. Typically, since the IAB node 1100 has a stronger transmitter and a better channel, due to a controlled deployment, towards the parent IAB node 1102, than normal devices, the IAB-MT would be instructed to decrease its transmission power towards the parent IAB node 1102. For normal devices, it is not a problem to decrease the power in a node since only the receiving node in the serving cell is affected by it. For IAB nodes, however, there may be a problem since simultaneously as the IAB-MT may transmit to a parent IAB node 1102, the IAB-DU must maintain its transmission power in its own cell. If the transmission power difference between the IAB-MT and the IAB-DU is too large, and the IAB node 1100 uses, e.g., a common transmitter, the stronger IAB-DU transmission may cause interference into the IAB-MT transmission due to EVM or ACLR requirements no longer being fulfilled. Hence, there may be a need for a trade-off between co-scheduling the IAB node 1100 with other nodes or devices when transmitting to the parent IAB node 1102 and what mode of operation the IAB node can operate in.

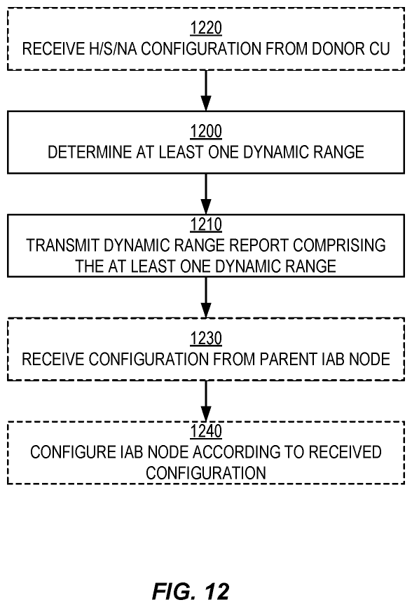

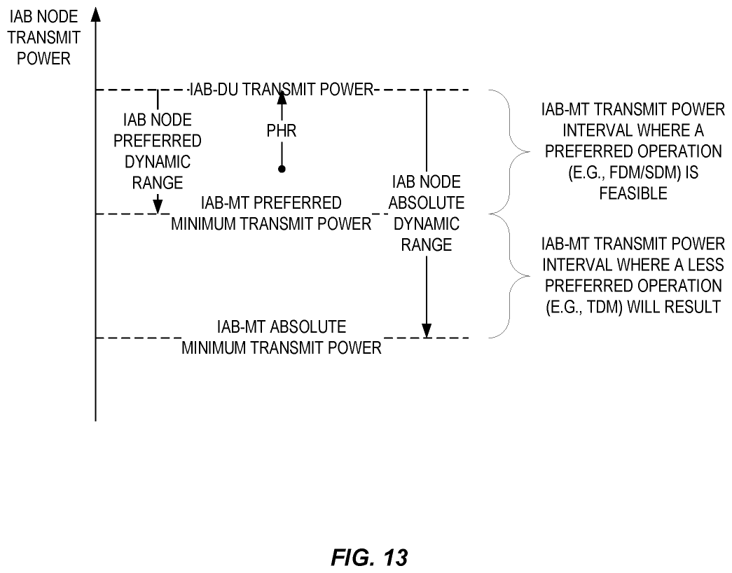

A first aspect of the invention is a method for signaling a power transmission dynamic range of an IAB node to another network node, as seen in FIG. 12. In a first step (block 1200), the IAB node determines at least one transmission dynamic range between two transmission powers of the IAB node. These two transmission powers may be a maximum transmission power and a minimum transmission power, or a present transmission power and a minimum transmission power. The minimum transmission power may, in turn, be an absolute minimum transmission power or a preferred minimum transmission power, see FIG. 13. The preferred minimum transmission power may in turn be related to a preferred mode of operation, e.g., simultaneous transmission, i.e., frequency or spatial multiplexing is used between IAB-MT and IAB-DU sides. The maximum transmission power may be determined in relation to the configured transmit power of the IAB-DU or IAB-MT. Hence, the IAB node may report a preferred dynamic range and/or an absolute dynamic range, corresponding to whether or not the IAB-DU will or can transmit at the same time as the IAB-MT.

In a second step (block 1210), the IAB node transmits a dynamic range report comprising the at least one dynamic range to the other network node.

In an optional step (block 1220), prior to determining the at least one dynamic range, the IAB node receives a H/S/NA configuration allowing it to include the space between the hard, soft and not available parts of the carrier when determining the dynamic range. This is beneficial since, e.g., ACLR is quickly decreasing with the spectral distance from the transmission sub-carrier and/or carrier, and hence allows the IAB node to make a better determination of its preferred minimum transmission power in relation to the maximum transmission power.

In a first optional step (block 1230), the IAB node receives a configuration message from the other network node and in a second optional step (block 1240), the IAB node configures itself according to the received configuration. This configuration may be related to the ability to operate in a simultaneous transmission mode, and/or it may be a power control message. The configuration may further be limited to a subset of the slots among a set of slots for which the IAB node is configured.

The above transmitted dynamic range report may be included in a capability report, Operations, Administration and Maintenance (OAM) report or in an RRC message, in which case the other network node is the central unit (CU).

Alternatively, the other node may be the parent IAB node, in which case the received configuration message may be an UL transmit power configuration. In this case, the dynamic range report may be transmitted in combination with a Power Headroom report. In this case the dynamic range can be reported to parent IAB-node using a Layer-1 or Layer-2 signaling.

In one embodiment, the transmitted dynamic range report may be transmitted to the CU and the received configuration message may be received from the parent IAB node.

### Parent IAB Node Aspect

(The Parent IAB Node Aspect is not Symmetrical to the IAB Node Aspect in that it Only Considers that Dynamic Signaling Associated with Power Control)

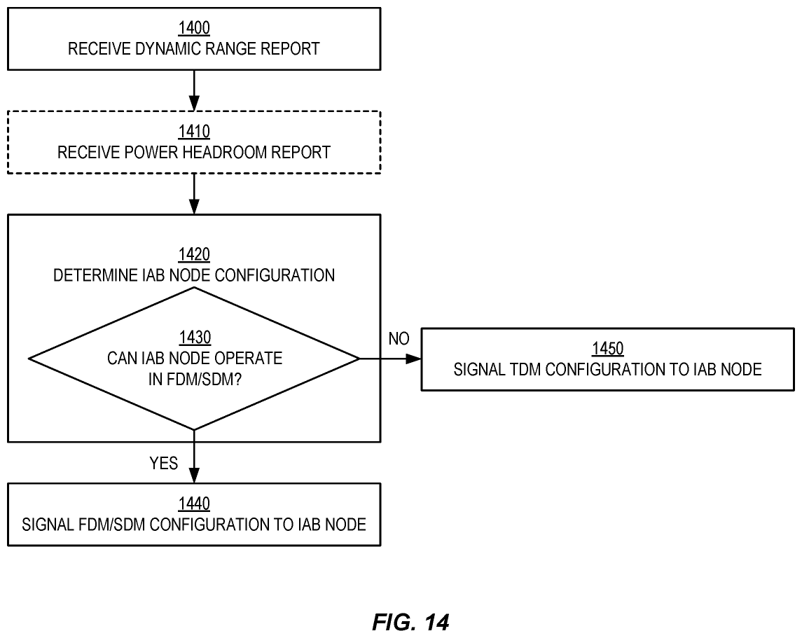

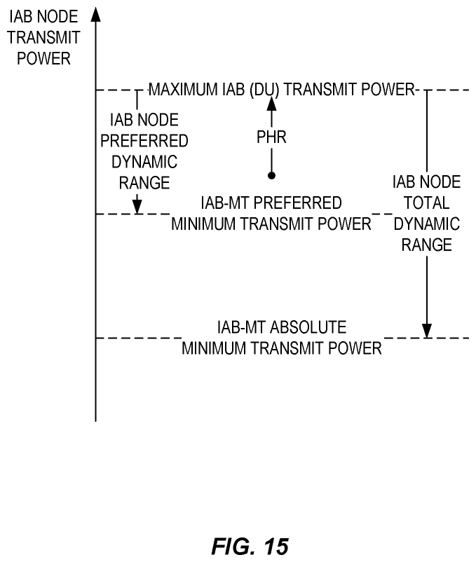

A second aspect of the invention is a method in a parent IAB node (or a CU), for configuring an IAB node, as seen in FIG. 14. In a first step (1400), the parent IAB node receives a dynamic range report from the IAB node. In an optional step (1410), the parent IAB node also receives a power headroom report. FIG. 15 illustrates how the dynamic range report and the power headroom report can be used to determine whether or not the IAB node is capable of a certain mode of operation. If the reported power headroom is smaller than the preferred dynamic range of the IAB node, the IAB node can operate in its preferred mode of operation, e.g., simultaneous transmission.

In a second step (1420), the other network node determines an IAB node configuration, based on the received dynamic range report. The IAB node configuration may be that the IAB node is capable of simultaneous operation, potentially conditioned on the IAB node being able to also change its IAB-MT transmission power. Simultaneous operation, in this aspect, may be that the IAB node is capable to simultaneously transmit on both its MT and DU sides. Alternatively, simultaneous operation may be that the IAB-MT is capable to transmit simultaneously as a device to the parent IAB-DU. In one embodiment, the determination may be based on a reception power threshold such that it is preferable for the parent IAB node to receive a signal from the IAB node above or below a certain threshold. This threshold may in turn be related to the received power from other IAB nodes or devices or related to a targeted received power for the parent IAB node, such that the dynamic range of the parent IAB node receiver allows for accurate decoding of all simultaneously received signals. The threshold may further be related to the receiver linearity of the parent IAB node, such that a higher linearity allows for a larger dynamic range in the parent IAB node's receiver.

In another embodiment, the determination may be based on traffic situation, such that for one situation it is beneficial that the IAB node operates in simultaneous transmission, e.g., to achieve a higher throughput or a lower latency or a combination thereof, whereas in another situation, it is beneficial for the parent IAB node to receive. In yet another embodiment, the parent IAB node may find it beneficial if the IAB node transmits in certain slots, possibly related to the reception of other devices or IAB nodes. In yet another embodiment, the determination may be based on the Quality of Service (QOS) requirements of the backhaul and access links, or a certain application. In some embodiments, the operations of block 1420 for determining the IAB node configuration may comprise determining whether the IAB node can operate in frequency domain multiplexing (FDM) and/or spatial domain multiplexing (SDM) (block 1430).

In a third step, the parent IAB node signals the determined configuration to the IAB node, in which the parent node determines whether FDM/SDM operation is possible (1440) or not (1450).

The configuration above may include modes of simultaneous operation, including no simultaneous operation as well as power control and/or timing in order to achieve a certain mode of operation.

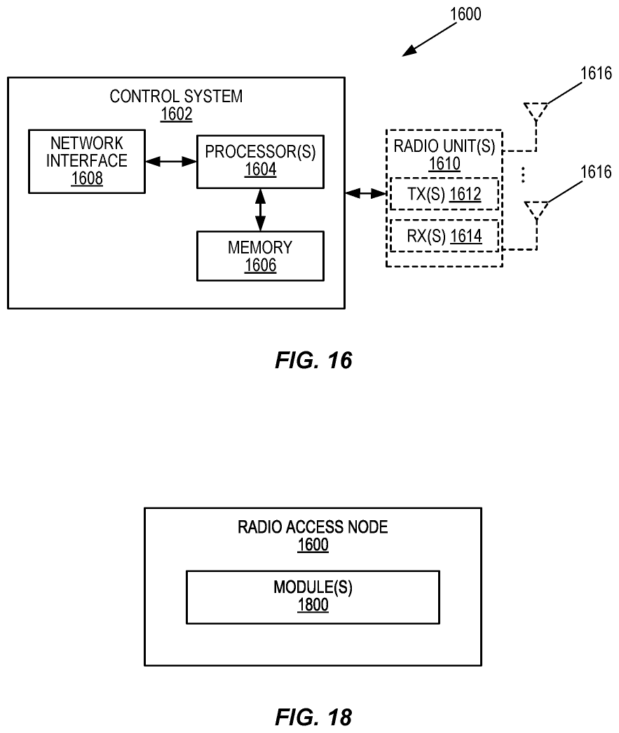

FIG. 16 is a schematic block diagram of a radio access node 1600, such as the IAB nodes described herein, according to some embodiments of the present disclosure. Optional features are represented by dashed boxes. The radio access node 1600 may be, for example, a base station 802 or 806 or a network node that implements all or part of the functionality of the base station 802 or gNB described herein. As illustrated, the radio access node 1600 includes a control system 1602 that includes one or more processors 1604 (e.g., Central Processing Units (CPUs), Application Specific Integrated Circuits (ASICs), Field Programmable Gate Arrays (FPGAs), and/or the like), memory 1606, and a network interface 1608. The one or more processors 1604 are also referred to herein as processing circuitry. In addition, the radio access node 1600 may include one or more radio units 1610 that each includes one or more transmitters 1612 and one or more receivers 1614 coupled to one or more antennas 1616. The radio units 1610 may be referred to or be part of radio interface circuitry. In some embodiments, the radio unit(s) 1610 is external to the control system 1602 and connected to the control system 1602 via, e.g., a wired connection (e.g., an optical cable). However, in some other embodiments, the radio unit(s) 1610 and potentially the antenna(s) 1616 are integrated together with the control system 1602. The one or more processors 1604 operate to provide one or more functions of a radio access node 1600 as described herein. In some embodiments, the function(s) are implemented in software that is stored, e.g., in the memory 1606 and executed by the one or more processors 1604.

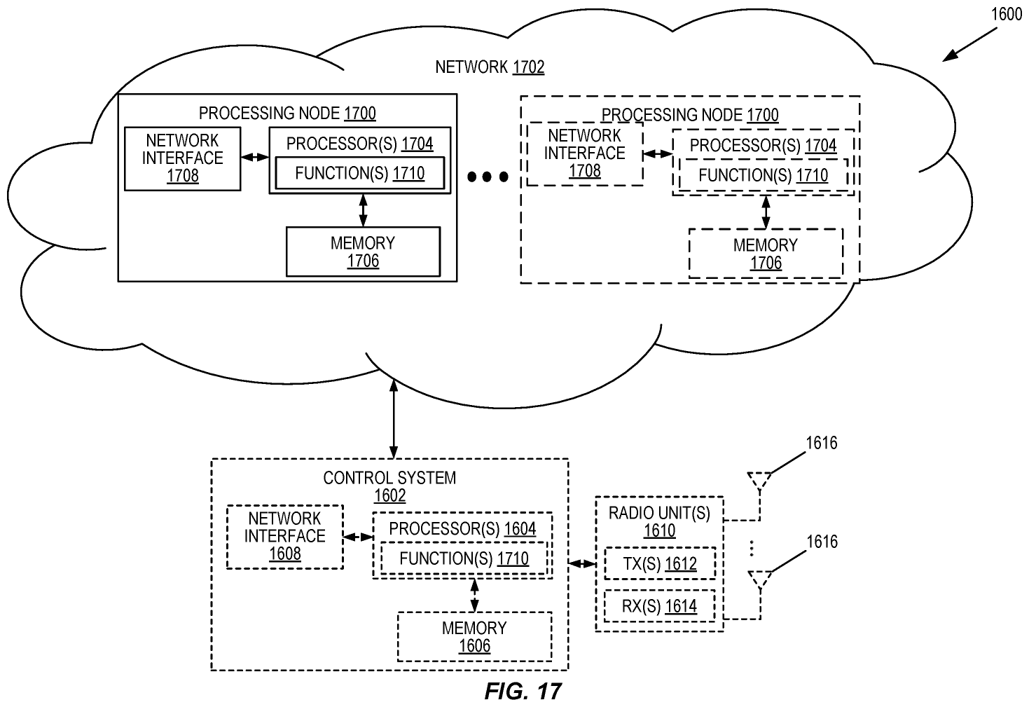

FIG. 17 is a schematic block diagram that illustrates a virtualized embodiment of the radio access node 1600 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1600 in which at least a portion of the functionality of the radio access node 1600 is implemented as a virtual component(s) (e.g., via a virtual machine(s) executing on a physical processing node(s) in a network(s)). As illustrated, in this example, the radio access node 1600 may include the control system 1602 and/or the one or more radio units 1610, as described above. The control system 1602 may be connected to the radio unit(s) 1610 via, for example, an optical cable or the like. The radio access node 1600 includes one or more processing nodes 1700 coupled to or included as part of a network(s) 1702. If present, the control system 1602 or the radio unit(s) are connected to the processing node(s) 1700 via the network 1702. Each processing node 1700 includes one or more processors 1704 (e.g., CPUs, ASICs, FPGAS, and/or the like), memory 1706, and a network interface 1708.

In this example, functions 1710 of the radio access node 1600 described herein are implemented at the one or more processing nodes 1700 or distributed across the one or more processing nodes 1700 and the control system 1602 and/or the radio unit(s) 1610 in any desired manner. In some particular embodiments, some or all of the functions 1710 of the radio access node 1600 described herein are implemented as virtual components executed by one or more virtual machines implemented in a virtual environment(s) hosted by the processing node(s) 1700. As will be appreciated by one of ordinary skill in the art, additional signaling or communication between the processing node(s) 1700 and the control system 1602 is used in order to carry out at least some of the desired functions 1710. Notably, in some embodiments, the control system 1602 may not be included, in which case the radio unit(s) 1610 communicate directly with the processing node(s) 1700 via an appropriate network interface(s).

In some embodiments, a computer program including instructions which, when executed by at least one processor, causes the at least one processor to carry out the functionality of radio access node 1600 or a node (e.g., a processing node 1700) implementing one or more of the functions 1710 of the radio access node 1600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 18 is a schematic block diagram of the radio access node 1600 according to some other embodiments of the present disclosure. The radio access node 1600 includes one or more modules 1800, each of which is implemented in software. The module(s) 1800 provide the functionality of the radio access node 1600 described herein. This discussion is equally applicable to the processing node 1700 of FIG. 17 where the modules 1800 may be implemented at one of the processing nodes 1700 or distributed across multiple processing nodes 1700 and/or distributed across the processing node(s) 1700 and the control system 1602.

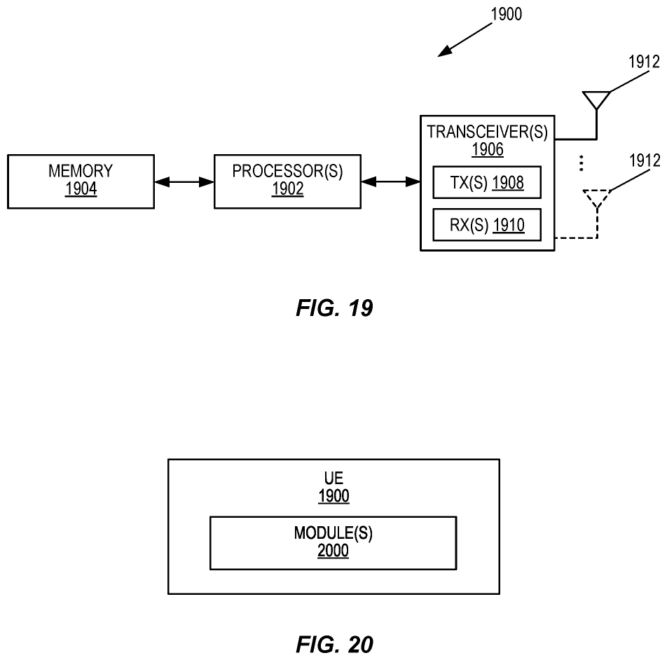

FIG. 19 is a schematic block diagram of a wireless communication device 1900 according to some embodiments of the present disclosure. As illustrated, the wireless communication device 1900 includes one or more processors 1902 (e.g., CPUs, ASICS, FPGAs, and/or the like), memory 1904, and one or more transceivers 1906 each including one or more transmitters 1908 and one or more receivers 1910 coupled to one or more antennas 1912. The transceiver(s) 1906 includes radio-front end circuitry connected to the antenna(s) 1912 that is configured to condition signals communicated between the antenna(s) 1912 and the processor(s) 1902, as will be appreciated by on of ordinary skill in the art. The processors 1902 are also referred to herein as processing circuitry. The transceivers 1906 are also referred to herein as radio circuitry. In some embodiments, the functionality of the wireless communication device 1900 described above may be fully or partially implemented in software that is, e.g., stored in the memory 1904 and executed by the processor(s) 1902. Note that the wireless communication device 1900 may include additional components not illustrated in FIG. 19 such as, e.g., one or more user interface components (e.g., an input/output interface including a display, buttons, a touch screen, a microphone, a speaker(s), and/or the like and/or any other components for allowing input of information into the wireless communication device 1900 and/or allowing output of information from the wireless communication device 1900), a power supply (e.g., a battery and associated power circuitry), etc.

In some embodiments, a computer program including instructions which, when executed by at least one processor, causes the at least one processor to carry out the functionality of the wireless communication device 1900 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 20 is a schematic block diagram of the wireless communication device 1900 according to some other embodiments of the present disclosure. The wireless communication device 1900 includes one or more modules 2000, each of which is implemented in software. The module(s) 2000 provide the functionality of the wireless communication device 1900 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method performed in an Integrated Access and Backhaul, IAB, network node for signaling a transmission power dynamic range of its IAB Mobile Termination, IAB-MT, to a second network node, the method comprising:
determining at least one dynamic range between two transmission power values; and
transmitting a dynamic range report to the second network node, wherein the dynamic range report comprises the at least one dynamic range.

Embodiment 2: The method of embodiment 1, wherein the two transmission power values comprise a maximum transmission power value and a minimum transmission power value.

Embodiment 3: The method of embodiment 1, wherein the two transmission power values comprise a present transmission power value and a minimum transmission power value.

Embodiment 4: The method of any one of embodiments 2 and 3, wherein the minimum transmission power value comprises one of an absolute minimum transmission power value and a preferred minimum transmission power value.

Embodiment 5: The method of embodiment 4, wherein the preferred minimum transmission power value is related to a mode of operation in the IAB network node.

Embodiment 6: The method of any one of embodiments 4 and 5, wherein the preferred minimum transmission power value is associated with simultaneous operation of IAB-MT and IAB Distributed Unit, IAB-DU.

Embodiment 7: The method of embodiment 2, wherein the maximum transmission power value is set in relation to an IAB-DU specified maximum transmit power.

Embodiment 8: The method of any one of embodiments 1 to 7, further comprising, prior to determining the at least one dynamic range, receiving a frequency configuration for frequency domain resource configuration and/or allocation.

Embodiment 9: The method of embodiment 8, wherein the preferred minimum transmission power is related one or more of a frequency separation between an IAB-MT and an IAB-DU allocation in a carrier and the bandwidth of the transmissions of the IAB-DU or the IAB-MT.

Embodiment 10: The method of any one of embodiments 1 to 9, further comprising, subsequent to transmitting the dynamic range report:
receiving a configuration message from the second network node; and
configuring the IAB network node according to the configuration message.

Embodiment 11: The method of any one of embodiments 1 to 10, wherein the dynamic range report is part of a capability report.

Embodiment 12: The method of embodiment 11, wherein the capability report comprises a multiplexing capability report.

Embodiment 13: The method of any one of embodiments 1 to 10, wherein the dynamic range report is part of a Radio Resource Control, RRC, message, an F1 Application Protocol, F1ap, message, or a Medium Access Control, MAC, control element, CE, message.

Embodiment 14: The method of any one of embodiments 1 to 13, wherein the second network node comprises a Central Unit, CU.

Embodiment 15: The method of any one of embodiments 1 to 10, wherein the dynamic range report is part of an Operations, Administration and Maintenance, OAM, report.

Embodiment 16: The method of embodiment 10, wherein:
the second network node comprises a parent IAB network node; and
the configuration message comprises an uplink, UL, power control message; and
configuring the IAB network node according to the configuration message comprises configuring an IAB-MT transmit power configuration.

Embodiment 17: The method of embodiment 16, wherein the dynamic range report is combined with a power headroom report.

Embodiment 18: The method of embodiments 14 or 16, further comprising:
determining, by the IAB network node, that a change in simultaneous operation mode is required; and
signaling a dynamic change in simultaneous operation mode to the parent IAB network node.

Embodiment 19: An Integrated Access and Backhaul, IAB, network node for signaling a transmission power dynamic range of its IAB Mobile Termination, IAB-MT, to a second network node, the IAB network node comprising one or more transmitters, one or more receivers, and processing circuitry associated with the one or more transmitters and the one or more receivers and configured to:
determine at least one dynamic range between two transmission power values; and
transmit a dynamic range report to the second network node, wherein the dynamic range report comprises the at least one dynamic range.

Embodiment 20: The IAB network node of embodiment 19, wherein the processing circuitry is further configured to perform the method of any one of embodiments 2 to 17.

Embodiment 21: An Integrated Access and Backhaul, IAB, network node for signaling a transmission power dynamic range of its IAB Mobile Termination, IAB-MT, to a second network node, the IAB network node adapted to:
determine at least one dynamic range between two transmission power values; and
transmit a dynamic range report to the second network node, wherein the dynamic range report comprises the at least one dynamic range.

Embodiment 22: The IAB network node of embodiment 21, further adapted to perform the method of any one of embodiments 2 to 17.

Embodiment 23: A method performed in an Integrated Access and Backhaul, IAB, parent network node for configuring an IAB network node, the method comprising:
receiving a dynamic range report from the IAB network node, the dynamic range report comprising at least one dynamic range between two transmission power values;
determining a configuration of the IAB network node based on the dynamic range report; and
transmitting a configuration message comprising the configuration to the IAB network node.

Embodiment 24: The method of embodiment 23, wherein the two transmission power values comprise a maximum transmission power value and a minimum transmission power value.

Embodiment 25: The method of embodiment 23, wherein the two transmission power values comprise a present transmission power value and a minimum transmission power value.

Embodiment 26: The method of any one of embodiments 24 and 25, wherein the minimum transmission power value comprises one of an absolute minimum transmission power value and a preferred minimum transmission power value.

Embodiment 27: The method of embodiment 26, wherein the preferred minimum transmission power value is related to a mode of operation in the IAB network node.

Embodiment 28: The method of any one of embodiments 26 and 27, wherein the preferred minimum transmission power value is associated with simultaneous operation of IAB-MT and IAB Distributed Unit, IAB-DU.

Embodiment 29: The method of embodiment 24, wherein the maximum transmission power value is set in relation to an IAB-DU specified maximum transmit power.

Embodiment 30: The method of embodiment 23, wherein the configuration message comprises an uplink, UL, power control message.

Embodiment 31: The method of embodiment 23, wherein the dynamic range report is combined with a power headroom report.

Embodiment 32: The method of any one of embodiments 23 to 31, further comprising comparing the dynamic range report to a threshold for simultaneous operation.

Embodiment 33: The method of embodiment 32, further comprising, responsive to determining that the IAB network node is capable of simultaneous operation, determining a configuration for simultaneous operation.

Embodiment 34: The method of embodiment 32, further comprising, responsive to determining that the IAB network node is capable of simultaneous operation given a change in configuration, signaling the change in configuration and a configuration for simultaneous operation to the IAB network node.

Embodiment 35: The method of any one of embodiments 33 and 34, wherein simultaneous operation comprises simultaneous transmission of IAB-MT and IAB-DU signals.

Embodiment 36: The method of embodiment 32, wherein the threshold for simultaneous operation is based on the receiver linearity of the parent IAB node.

Embodiment 37: The method of any one of embodiments 23 to 36, wherein the configuration is valid for a subset of slots

Embodiment 38: The method of any one of embodiments 23 to 37, wherein the configuration comprises one or more of a mode of simultaneous operation, a mode of no simultaneous operation, power control, and timing.

Embodiment 39: An Integrated Access and Backhaul, IAB, parent network node for configuring an IAB network node, the IAB parent network node comprising one or more transmitters, one or more receivers, and processing circuitry associated with the one or more transmitters and the one or more receivers and configured to:
receive a dynamic range report from the IAB network node, the dynamic range report comprising at least one dynamic range between two transmission power values;
determine a configuration of the IAB network node based on the dynamic range report; and
transmit a configuration message comprising the configuration to the IAB network node.

Embodiment 40: The IAB parent network node of embodiment 39, wherein the processing circuitry is further configured to perform the method of any one of embodiments 24 to 38.

Embodiment 41: An Integrated Access and Backhaul, IAB, parent network node for configuring an IAB network node, the IAB parent network node adapted to:
receive a dynamic range report from the IAB network node, the dynamic range report comprising at least one dynamic range between two transmission power values;
determine a configuration of the IAB network node based on the dynamic range report; and
transmit a configuration message comprising the configuration to the IAB network node.

Embodiment 42: The IAB parent network node of embodiment 41, further adapted to perform the method of any one of embodiments 24 to 38.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IOT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed in an Integrated Access and Backhaul, IAB, network node for signaling a transmission power dynamic range of its IAB Mobile Termination, IAB-MT, to a second network node, the method comprising:
determining at least one dynamic range between two transmission power values; and
transmitting a dynamic range report to the second network node, wherein the dynamic range report comprises the at least one dynamic range,
wherein the two transmission power values comprise a maximum transmission power value and an offset.

2. (canceled)

3. The method of claim 1, wherein the offset comprises a difference between the maximum transmission power and an IAB-MT desired minimum transmit power.

4. (canceled)

5. The method of claim 1, wherein the two transmission power values comprise a maximum transmission power value and a minimum transmission power value.

6. The method of claim 1, wherein the two transmission power values comprise a present transmission power value and a minimum transmission power value.

7. The method of claim 5, wherein the minimum transmission power value comprises either one of an absolute minimum transmission power value or a preferred minimum transmission power value.

8. The method of claim 7, wherein the preferred minimum transmission power value is related to a mode of operation in the IAB network node, wherein the at least one dynamic range is based on a mode of operation in the IAB network node, wherein the mode of operation comprises one or more of frequency domain resource multiplexing, spatial domain resource multiplexing or time domain resource multiplexing.

9. The method of claim 7, wherein the preferred minimum transmission power value is associated with simultaneous operation of IAB-MT and IAB Distributed Unit, IAB-DU.

10-14. (canceled)

15. The method of claim 1, further comprising, subsequent to transmitting the dynamic range report:
receiving a configuration message from the second network node; and
configuring the IAB network node according to the configuration message.

16. The method of claim 1, wherein the dynamic range report is part of a capability report.

17. The method of claim 16, wherein the capability report comprises a multiplexing capability report.

18. The method of claim 1, wherein the dynamic range report is part of a Radio Resource Control, RRC, message, an F1 Application Protocol, F1ap, message, or a Medium Access Control, MAC, control element, CE, message.

19. The method of claim 1, wherein the second network node comprises a Central Unit, CU.

20. The method of claim 1, wherein the dynamic range report is part of an Operations, Administration and Maintenance, OAM, report.

21. The method of claim 15, wherein:
the second network node comprises a parent IAB network node;
the configuration message comprises an uplink, UL, power control message; and
configuring the IAB network node according to the configuration message comprises configuring an IAB-MT transmit power configuration.

22. The method of claim 19, further comprising:
determining, by the IAB network node, that a change in simultaneous operation mode is required; and
signaling a dynamic change in simultaneous operation mode to the parent IAB network node.

23. An Integrated Access and Backhaul, IAB, network node for signaling a transmission power dynamic range of its IAB Mobile Termination, IAB-MT, to a second network node, the IAB network node comprising one or more transmitters, one or more receivers, and processing circuitry associated with the one or more transmitters and the one or more receivers and configured to:
determine at least one dynamic range between two transmission power values; and
transmit a dynamic range report to the second network node, wherein the dynamic range report comprises the at least one dynamic range.

24-26. (canceled)

27. A method performed in an Integrated Access and Backhaul, IAB, parent network node for configuring an IAB network node, the method comprising:
receiving a dynamic range report from the IAB network node, the dynamic range report comprising at least one dynamic range between two transmission power values;
determining a configuration of the IAB network node based on the dynamic range report; and
transmitting a configuration message comprising the configuration to the IAB network node, wherein the two transmission power values comprise a maximum transmission power value and an offset.

28. (canceled)

29. The method of claim 27, wherein the offset comprises a difference between the maximum transmission power and an IAB-MT desired minimum transmit power.

30. (canceled)

31. The method of claim 27, wherein the two transmission power values comprise a maximum transmission power value and a minimum transmission power value.

32. The method of claim 27, wherein the minimum transmission power value comprises one of an absolute minimum transmission power value and a preferred minimum transmission power value.

33. The method of claim 32, wherein the preferred minimum transmission power value is related to a mode of operation in the IAB network node, wherein the at least one dynamic range is based on a mode of operation in the IAB network node, wherein the mode of operation comprises one or more of frequency domain resource multiplexing, spatial domain resource multiplexing or time domain resource multiplexing.

34. The method of claim 32, wherein the preferred minimum transmission power value is associated with simultaneous operation of IAB-MT and IAB Distributed Unit, IAB-DU.

35-37. (canceled)

38. The method of claim 27, wherein the configuration message comprises an uplink, UL, power control message.

39. The method of claim 27, further comprising comparing the dynamic range report to a threshold for simultaneous operation.

40. The method of claim 39, further comprising, responsive to determining that the IAB network node is capable of simultaneous operation, determining a configuration for simultaneous operation.

41. The method of claim 39, further comprising, responsive to determining that the IAB network node is capable of simultaneous operation given a change in configuration, signaling the change in configuration and a configuration for simultaneous operation to the IAB network node.

42. The method of claim 40, wherein simultaneous operation comprises simultaneous transmission of IAB-MT and IAB-DU signals.

43. The method of claim 39, wherein the threshold for simultaneous operation is based on the receiver linearity of the parent IAB node.

44. The method of claim 27, wherein the configuration is valid for a subset of slots.

45. The method of claim 27, wherein the configuration comprises one or more of a mode of simultaneous operation, a mode of no simultaneous operation, power control, and timing.

46. An Integrated Access and Backhaul, IAB, parent network node for configuring an IAB network node, the IAB parent network node comprising one or more transmitters, one or more receivers, and processing circuitry associated with the one or more transmitters and the one or more receivers and configured to:
receive a dynamic range report from the IAB network node, the dynamic range report comprising at least one dynamic range between two transmission power values;
determine a configuration of the IAB network node based on the dynamic range report; and
transmit a configuration message comprising the configuration to the IAB network node.

47-49. (canceled)
